(19) United States
(12) Patent Application Publication
(10) Pub. No.: US 2022/0044480 A1
(43) Pub. Date: Feb. 10, 2022

(54) SYSTEM FOR THREE DIMENSIONAL EXTENSION WITH MULTISCREEN EXTENDED REALITY

(71) Applicant: AT&T Intellectual Property I, L.P., Atlanta, GA (US)

(72) Inventors: Eric Zavesky, Austin, TX (US); James Pratt, Round Rock, TX (US)

(73) Assignee: AT&T Intellectual Property I, L.P., Atlanta, GA (US)

(21) Appl. No.: 16/986,735

(22) Filed: Aug. 6, 2020

(51) Int. Cl. G06T 19/00; G06T 1/00; G06K 9/00

(52) U.S. Cl. CPC G06T 19/006; G06T 2200/24; G06K 9/00724; G06T 1/0021

(57) ABSTRACT

Aspects of the subject disclosure may include, for example, receiving a content item for displaying in a display system, the display system having a viewing plane, identifying an object in the content item, initiating an immersive experience for a user, wherein the immersive experience is based on the identifying an object and wherein the immersive experience includes a virtual object based on the object and presented in a virtual environment with the user and appearing to the user to move from the viewing plane of the display system into the virtual environment with the user, and providing data defining the immersive experience to extended reality hardware for interaction by the user. Other embodiments are disclosed.

### FIELD OF THE DISCLOSURE

The subject disclosure relates to a system for three-dimensional extension with multiscreen extended reality (XR).

### BACKGROUND

Conventional two-dimensional display systems provide video display for viewing by a user, but opportunities for three-dimensional immersion are limited.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a block diagram illustrating an example, non-limiting embodiment of a system functioning within the communication network of FIG. 1 in accordance with various aspects described herein.

FIG. 2B is a block diagram illustrating operation of an example, non-limiting embodiment of a system functioning within the communication network of FIG. 1 in accordance with various aspects described herein

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for combining a passive onscreen viewing system with an active, extended reality (XR) viewing environment in order to enhance the overall experience. A two-dimensional video and audio experience can be given spatial depth by combining with XR equipment. Other embodiments are described in the subject disclosure.

One or more aspects of the subject disclosure include receiving a content item for displaying in a display system, the display system having a viewing plane, identifying an object in the content item, initiating an immersive experience for a user, wherein the immersive experience is based on the identifying an object and wherein the immersive experience includes a virtual object based on the object and presented in a virtual environment with the user and appearing to the user to move from the viewing plane of the display system into the virtual environment with the user, and providing data defining the immersive experience to extended reality hardware for interaction by the user.

One or more aspects of the subject disclosure include receiving information defining a two-dimensional video content item and displaying the two-dimensional video content item on a two-dimensional display system having a viewing plane. The subject disclosure further includes identifying an object in the two-dimensional video content item, the object being viewable by a user in a video presentation on the two-dimensional display system, and initiating an immersive experience for displaying to a user on extended reality hardware operated in conjunction with the two-dimensional display system. In exemplary embodiments, the immersive experience includes presenting on the extended reality hardware a virtual object presented in a virtual environment with the user and appearing to the user to move from the viewing plane of the two-dimensional display system into the virtual environment with the user, wherein the virtual object is based on the object. Exemplary embodiments further include providing, to the extended reality hardware, data defining the immersive experience, receiving user interaction with the virtual object in the virtual environment, modifying an aspect of the virtual object responsive to the user interaction with the virtual object, and providing, to the extended reality hardware, updated data defining a modified aspect of the virtual object.

One or more aspects of the subject disclosure include receiving a video content item for display to a user on a two-dimensional display system, the two-dimensional display system having a viewing plane and identifying a moving object in the video content item when the video content item is displayed on the two-dimensional display system, wherein the moving object has visual properties, and wherein the moving object appears to move toward the viewing plane of the two-dimensional display system. Exemplary embodiments further include generating a virtual object having visual properties matching the visual properties of the moving object and providing data defining the virtual object to extended reality hardware viewable by the user together with the two-dimensional display system, the extended reality hardware displaying a three-dimensional virtual environment to the user in a physical environment spaced from the viewing plane of the two-dimensional display system, the data defining the virtual object causing the virtual object to appear to move from the viewing plane of the two-dimensional display system toward the user in the three-dimensional virtual environment.

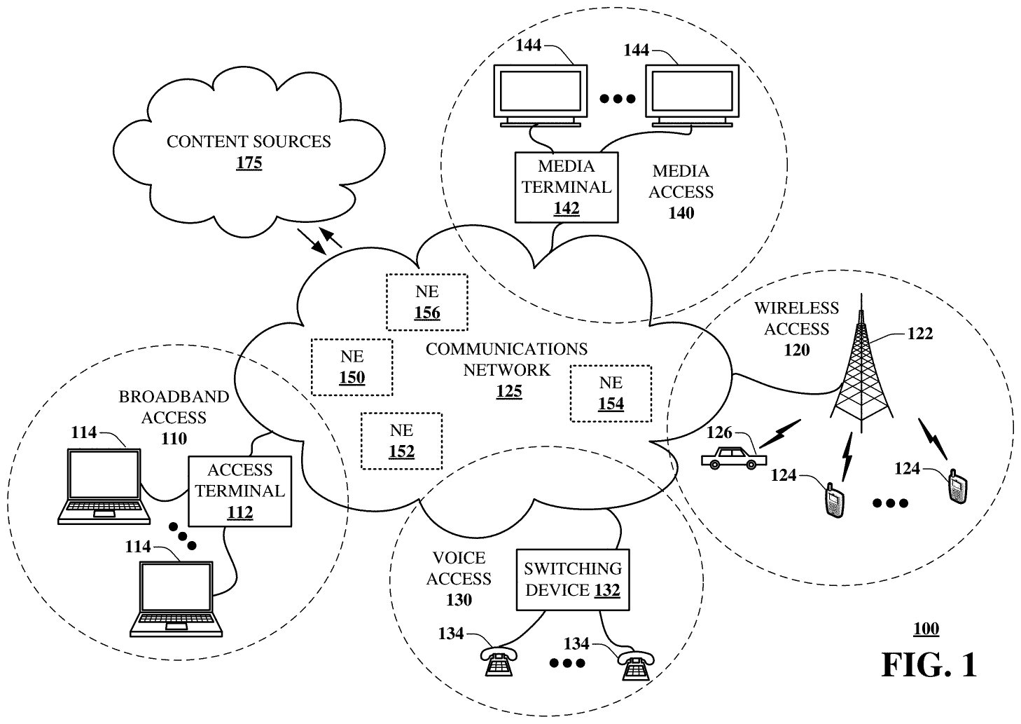

Referring now to FIG. 1, a block diagram is shown illustrating an example, non-limiting embodiment of a system 100 in accordance with various aspects described herein. For example, system 100 can facilitate in whole or in part receiving a two-dimensional content item over a network for viewing by a user, identifying a moving object in the two-dimensional content item and initiating a three-dimensional extended reality immersive experience for viewing by the user in conjunction with the two-dimensional content item to create effect that the moving object is moving into the virtual environment of the immersive experience toward the user. In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

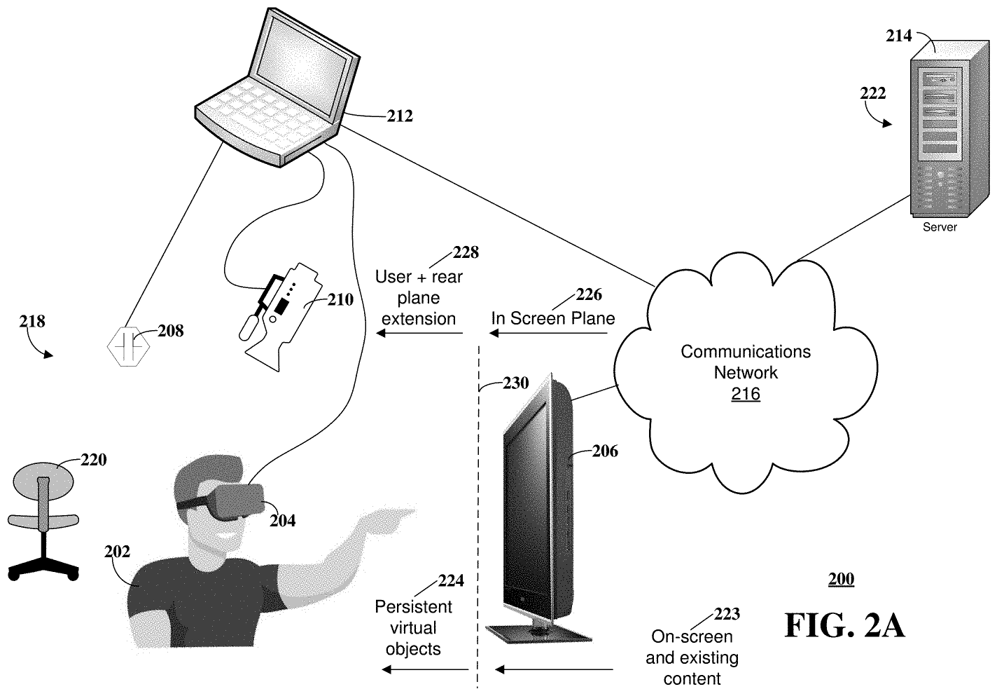

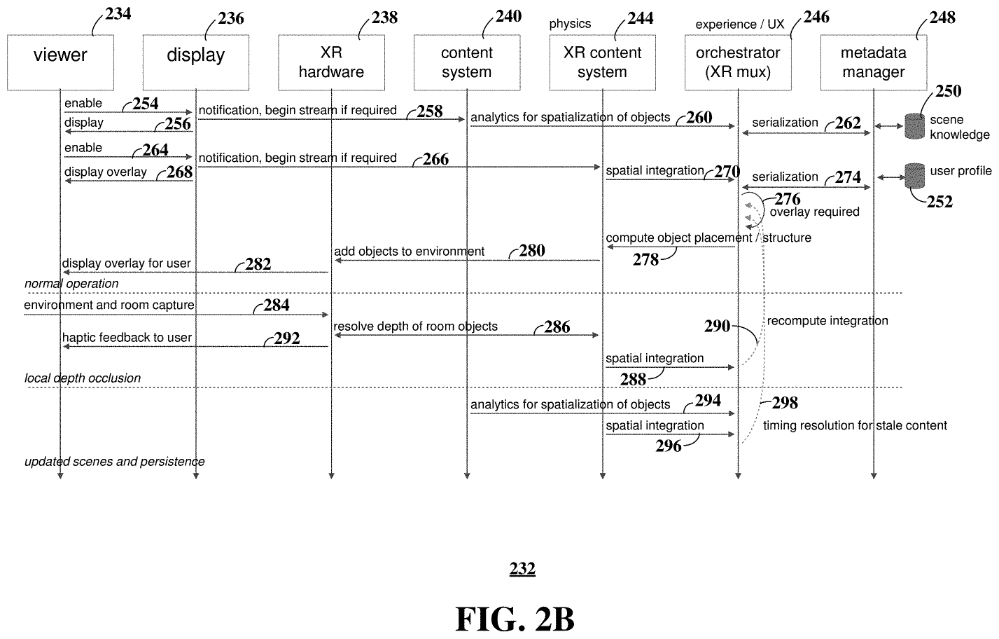

FIG. 2A is a block diagram illustrating an example, non-limiting embodiment of a system 200 functioning within the communication network of FIG. 1 in accordance with various aspects described herein. The system 200 enables extension of viewing by a user 202 of a video content item using an extended reality (XR) environment. An XR environment may include a combination of real world actions and items and virtual actions and items. The real world environment and virtual environments are combined through data processing technology such as system 200 to produce an XR environment. The user 202 may interact with the XR environment using various equipment and techniques to participate in an immersive experience.

Video content is becoming increasingly immersive. Immersive technology allows creation of an immersive experience for a user such as user 202. An immersive experience includes or presents an environment that is, at least in part, illusory and that seems to partially or completely surround the user so that the user feels to be inside the immersive experience and to be a part of the immersive experience. An immersive environment allows the user to experience some things that are physically impossible. An immersive experience may have the effect of augmenting reality or the real world by combining real world features, or supplementing them or replacing them, with artificially created features. Providing specific examples, an immersive experience can vary from a VR game that places the user in a situation where she or he must escape from a farm where a clown has gone mad. The depth of the immersion is enhanced with visuals, audio, and a narrative where one or more virtual characters demonstrate adversarial views. In another example, one or more users may be in an immersive experience while touring certain areas of a national park, like Grand Canyon National Park. As part of the AR experience, boulders fall during a simulated earthquake to demonstrate the chaos of nature. The user may see, hear, and even feel the boulders falling in the direction of the user. Examples of non-immersive experiences include a VR game about mathematics that uses simple numbers, sounds, and a flat display on a display screen to demonstrate addition, or an AR system that displays only textual enhancements (e.g. floating graphical signs) to a painting in a museum display. To further differentiate, if either the VR game or the AR system above were modified to include demonstrations from historical figures, direct addressing of the user, or any activity that invokes the philosophical phrases “suspension of disbelief” or “suspend judgement concerning the implausibility of the narrative,” each may be considered an immersive experience.

In some implementations of an XR environment, the user views a display screen such as a television or other system combined with a flat, two-dimensional display screen. The display screen is located in the room or other environment with the user. As content becomes more immersive, edges of the display screen and the user environment will continue to blend. That is, rather than being bound by the two-dimensional limits of the display screen in front of the user, an immersive experience will tend to surround the user, extending into the third dimension between, around and even behind the user. The immersive experience will be difficult to maintain with one or more flat display screens positioned in front of the user.

One solution to extend the user's field of view is to add additional display screens that extend the transmitted surface. For example two-dimensional content can be extended around walls of a room to appear to have greater depth. However, such a solution is not personalized for the user's particular environment, meaning the space or room where the user is located, including furniture, objects and people in that space. Nor is such a solution optimized for foreground and background object transmission. Additionally, high action content, such as sports presentations or semi-interactive games currently lack persistence for each user's environment. If viewing a hockey game or baseball game and the puck or ball goes off the display screen, the user is left to the two-dimensional capture device to rediscover it instead of a full three-dimensional environment. Further, existing XR systems may simply overlay an object according to metadata for three-dimensional spatial placement, including video and audio, which could violate a user's actual, physical environment. For example, a conventional XR system may display to the user a virtual cat which is off-screen of a video display but which seems to appear physically inside of a sofa because the cat was not properly obscured by a depth computation or other error. The system 200 addresses some of the limitations in conventional systems.

The system 200 in this embodiment includes an XR headset 204 wearable by the user 202, a display system 206, one or more sensors 208, one or more cameras 210, a user computer 212, and an AR server 214 accessible over a communications network 216. The user 202, the XR headset 204 and the display system are generally located together in an environment 218 which includes objects such as walls and a floor and furniture such as a chair 220. The environment 218 may include other people and any other objects.

The XR headset 204 enables the user 202 to experience, generally, an XR environment, where XR is a general term intended to encompass XR, VR and augmented reality (AR) systems, equipment and environments. The XR headset 204 generally includes a data processing system including one or more processors, a memory for storing data and instructions, and a communication interface. The XR headset 204 provides visual display to the user 202 and may include one or more display screens within the XR headset 204 to control the view seen by the user 202 and the environment experienced by the user 202. The XR headset 204 generally provides to the user a panoramic view around the user's head. Further, the XR headset 204 may include a camera for capturing images of the environment of the user 202. The XR headset 204 may include speakers to provide sound information to the user 202 and the XR headset 204 may include one or more microphones to collect sound information about the environment of the user 202. In other embodiments, the XR headset 204 may be embodied as AR glasses or other wearable devices.

In the illustrated embodiment, the XR headset 204 is operated in conjunction with the display system 206. The display system 206 may be a fixed display screen such as a computer monitor, television, projection screen, a ubiquitous wall display, an in-seat or in-dash holographic display, or a series of display screens in the physical environment 218 with the user 202. The display system 206 may include a display screen, a set-top box, a connected theater projector, a server or other processing system. The display system 206 may include a communications interface for data communications such as over the communications network 216. Further, the display system 206 may communicate directly with the XR headset 204, the user computer 212 or any combination of these. Such communications may be performed wirelessly or over wireline connections, or by combination.

The XR headset 204, including visual and audible capabilities, extends the virtual field of view and, in some embodiments, the virtual field of hearing of the user 202. The XR headset 204 can cause the user 202 to see and hear virtual objects in locations outside of the display screen of display system 206, or beyond the edges of the display screen of the display system 206. The display system 206 is limited to displaying images on the surface of a display screen. Such images are essentially two-dimensional, even if portraying a three-dimensional space. Some video is encoded to provide an apparent three-dimensional view of objects displayed by the display system 206. Similarly, the audio accompanying the video may be encoded to provide a three-dimensional depth or surround sound. However, in the environment 218, all images appear to be located on the display screen of the display system 206.

The sensors 208 may include any sort of condition sensing and data collection apparatus suitable for the embodiment of the system. The sensors 208 may include environmental sensors that collect information such as temperature, wind speed, orientation or acceleration, or other physical factors of the environment 218 where the user 202 is located. The sensors 208 may further gather information about the user 202. Such information may include biometric information, such as pulse rate or respiratory rate, skin conductivity, pupil dilation, haptic information about one or more touches of the user 202, and so forth. Thus, the sensors 208 may include or be part of a wearable device such as a watch, belt or harness. Further, such user data may include information about the position, posture and movement of the user 202. In some embodiments, the sensors 208 merely sense a condition and report information. In other embodiments, one or more of the sensors 208 may be controllable, such as by the user computer 212.

The camera 210 may include one or more cameras that collect images of the user 202 and the physical environment 218 near the user 202. For example, the camera 210 may be controlled by the user computer 212 or another device to collect images of the environment 218 to identify objects and individuals in the environment 218 such as the chair 220. Images from the camera 210 may be used to develop and inventory or map of the environment for use by the user computer 212 or the AR server 214. The camera 210 may collect visual images, infra-red images and others. The camera 210 may include one or more cameras including, for example, a camera that is part of the XR headset 204. The camera may also collect images in various formats such as color (RGB) pixels, depth maps (three-dimensional sensing from time-of-flight sensing or another algorithm), or thermal heatmaps, using infrared or other sensor designs.

The user computer 212 in the illustrated embodiment is in data communication with the XR headset 204, the display system 206, the sensors 208, and the camera 210. In the illustrated embodiment, the user computer 212 has wireline connections to the XR headset 204, the sensors 208 and the camera 210. In other embodiments, the wireline connections may be supplemented or replaced with one or more wireless connections, such as a WiFi connection according to the IEEE 802.11 family of standards or a Bluetooth connection according to the Bluetooth standard.

The user computer 212 cooperates with the XR headset 204 and the display system 206 to provide an XR environment in combination with video and audio content presented by the display system 206 for the user 202. The user computer 212 communicates with the XR headset 204 to provide video information, audio information and other control information to the XR headset 204 and to coordinate video, audio and multimedia presentations between the display system 206 and the XR headset 205. The user computer 212 communicates with the sensors 208 to collect information about the physical environment 218 and the user 202. The user computer 212 communicates with the AR server 214 to provide video and other information from the XR headset 204 to the AR server 214 and to provide information and data from the sensors 208 to the AR server 214. The video and data may be sent in any suitable format, including encoding to reduce the amount of data transmitted or encrypted to maintain security of the data. The user computer 212 communicates to the display system 206 video information which may be two-dimensional (2D) video or three-dimensional (3D) video. The user computer 212 communicates virtual reality information to the XR headset 204. The user computer 212 coordinates XR video, audio and multimedia information presented to the user by the XR headset 204 with video, audio and other information presented to the user by the display system 206.

In some embodiments, the functionality provided by the user computer 212 may be combined with the XR headset 204. In the embodiment of FIG. 2A, the user computer 212 is shown as a laptop computer. However, any suitable processing system, including one or more processors, memory and communications interface, may implement the functions of the user computer 212.

The AR server 214 in some embodiments controls provision of the XR environment to the VR headset 204 and video and audio content to the display system 206 for the user 202. The AR server 214 generally includes a processing system including one or more processors, a memory for storing data and instructions and a communications interface. The AR server 214 may be implemented as a single server computer, as multiple server computers at one or multiple locations or in any suitable manner. In the system 200, the AR server 214 implements an augmented reality (AR) engine 222.

The AR server 214 receives over the communications network 216 information about the environment 218 of the user 202, including location information, information about objects such as chair 220 in the environment 218 and events occurring in the environment 218. The AR server 214 in some embodiments may further receive information about the user 202 including biometric information and information about the performance of the user 202. The information may come from the sensors 208, the XR headset 204, or any other source. Under control of the AR engine 222, the AR server 214 provides control information over the communications network 216 including video information, sound information, haptic information and any other information, including instructions and data, to the other components of the system 200 including the user computer 212 and the XR headset 204.

The AR engine 222 develops the XR environment as a combination of the physical environment 208 in which the user 202 is located and a simulated or virtual environment, to achieve ends such as entertainment, sports immersion, extension of three-dimensional objects into a scene displayed on the display system 206, education, and marketing for the user 202. For example, if the user 202 is being trained using the system 200, the AR engine 222 may populate the environment 218 with virtual objects to mat the on-screen display on the display system 206 and provide objects that are synchronized to the view on screen and the background of the environment 218 including items such as the chair 220.

In a sports immersion use case, the AR engine 222 may allow a game piece such as a hockey puck or ball displayed on the screen of the display system 206 to appear to come to life in the three-dimensional environment and go off-screen of the display system 206 as part of the immersive view of the game. This feature makes use of volumetric rendering by the XR headset 204, for example.

In another example of the sports immersion use case, the AR engine 222 may allow a view of the area or field where the game is occurring to appear to extend around the user based on the user's apparent position on the field. The XR headset 204 provides to the user 202 the requisite images. Thus, in one example, as a ball in the image is passed overhead, the camera creating the image does not need to refocus. Instead, the user can look behind in the environment 218.

In the use case involving extension of three-dimensional objects into a scene displayed on the display system 206, the AR engine 222 may operate to increase relative immersion for object off screen and increase depth of field for local objects. In the use case involving marketing, the AR engine 222 can operate to include background objects for advertisements that can be linked to content loosely but changed for context while still being subtle or nonintrusive. For example advertisements can be displayed behind the user, or appear relatively far away, etc.

The communications network 216 may include any combination of wireline and wireless communication networks, including but not limited to broadband access 110, wireless access 120, voice access 130 and media access 140 (FIG. 1). The communications network 216 may include the internet and may provide access to other devices and services as well.

Conventional systems are known to display apparent three-dimensional images. These may include red-blue filtered glasses or image blanking to control what is seen by a viewer's right and left eyes. Such conventional systems may be termed passive systems in that they do not observe the environment where a viewer is located or change based on the viewer's environment. For example, if an object appears to fly toward the viewer of a conventional system but the environment where the user is located has an occlusion such as furniture that is blocking part of the display screen, the conventional passive system has no awareness of the occluding object and cannot account for it and will cause the object to appear to fly through or cut or intersect with the occluding object. Additionally, most conventional systems are limited to a single, non-coordinated display such that if the user turns away from the display (e.g. has one or no eyes directed at the display), the three-dimensional immersion is lost. In contrast, a system in accordance with the disclosure herein is active in nature in that such a system uses three-dimensional technology to learn the environment 218 where the user 202 is located. The system 200 in some embodiments can identify the position and movements of the user 202 and objects such as the chair 220 in the environment 218. The system 200 can then control the presentation of the immersive experience for the user accordingly. Images in the immersive experience that would be blocked by an occluding object can be actively modified to account for the occlusion.

In FIG. 2A, the user 202 views the display system 206. On the display system 206, the user 202 sees two-dimensional images and video. Further, the user 202 may see some limited three-dimensional images using various technologies such as depth-encoding applied to the two-dimensional display system 206. The environment 218 may be a room in the home of the user 202, a theater seating many viewers including the user 202, or any other space. The display system 206 provides video images of on-screen and existing content 223. The user 202 wears XR headset 204 or other device that displays persistent virtual objects 224. The persistent virtual objects 224 appear to be projected into the environment 218 around the user 202. An example involves the user 202 watching a sporting event such as a hockey game using the system 200. If a hockey puck is hit in the vicinity of a camera on-site capturing the hockey game, the puck may fly in the direction of the camera and past the camera. The motion in the direction to the camera will be displayed on the display system 206. As the puck moves past the camera, the system 200 will coordinate the two-dimensional view with a three dimensional view displayed to the user by the XR headset 204. The system 200 will track the trajectory, velocity, and size of the puck and display the appropriate images on the XR headset 204. As a result, the user 202 will see the puck flying in the user's direction and then past the user, and perhaps land in the environment behind the user. The images are coordinated by the system 200 to create the visual effect for the user 202.

In FIG. 2A, there is an apparent interface between a viewing plane or in-screen plane 226 and the user and rear plane extension 228. During operation of the system, objects displayed on the in-screen plane 226 may appear to move beyond the in-screen plane 226 and into the user and rear plane extension 228. In conventional three-dimensional systems, an object appears to come toward the viewer but essentially stops or comes no farther than the in-screen plane 226. In contrast, the system 200 causes the object to appear to move into the user and rear plane extension 228, so that the object persists or continues its apparent motion into the environment 218 and past the in-screen plane 226. The object may even appear to move next to and past and behind the user 202. The system 200 creates an automated connection between the two-dimensional images displayed on the display system 206 and three-dimensional immersion displayed on the XR headset 204.

The system 200 combines the display system 206 with a display unit that is local to the user 202, namely in this embodiment the XR headset 204. In this manner, the system 200 combines a source of information, including the on-screen and existing content 223 originating with the display system 206, with an additional source of information, the persistent and virtual objects 224, originating with the XR headset 204. The result is an immersive experience that combines the local information and remote information. The system 200 then allows the immersive experience to go beyond the spatial limitation created by the plane of the screen of the display system 206. This is an enhancement to the immersive experience that would not be available using the display system 206 alone or using the XR headset 204 alone. The on-screen and existing content 223 is made to combine with the environment 218 where the user 202 is located.

In some embodiments, the system 200 may be combined in a single unit such as the display system combined with the XR headset 204, including all data processing and communication abilities and devices. In such embodiments, the system can run on an individual environment, such as the home theater system or home television of the user 202. In such embodiments, operation of the user computer 212, the AR engine 222 and the AR server 214 are combined and maintained locally with the user 202 as a self-contained entertainment unit. Further, in some embodiments, the immersion can be used with or provided to any suitable XR device such as the XR headset 204, glasses, a volumetric display and other local devices. No unique technology is required for the user 202.

In some embodiments, the system 200 uses devices including the sensors 208 and camera 210 to combine environmental features such as chair 220 with the XR immersive experience. The system 200 combines spatialization recognition using the computer vision, such as from camera 210, sensors and other information to determining positioning in the environment 218. The system combines this information with on-screen content to provide to the user a sense interaction between on-screen content and the objects in the environment. The hockey puck that flies past the user 202 can appear to land on the chair 220 because the system 200 has identified and located the chair 220 in the environment 218 and determined a trajectory for the hockey puck that lands the virtual puck on the chair in the XR immersion.

In some embodiments, partitioning between the foreground and the background can be done to highlight items of particular interest in the immersive experience. For example, the system 200 may cause the object of interest to appear to move from the background in the on-screen and existing content 223 on the in-screen plane 226 into the user and rear plane extension 228 as a persistent virtual object 224. The object of interest may be moved or rotated, virtually by the system, for entertainment, education and other purposes. The visual enhancement may be accompanied by other sensory stimuli, such as audio voice over and haptic exposure, to further enhance the experience. In another example, the system 200 may identify an environment displayed in the content stream displayed on the display system 206 and automatically create a virtual environment in the space near the user. For example, the data stream of the content may include metadata which cues the system 200 about the environment, such as describing furniture or equipment displayed in the content. Alternatively, the system 200 may use pattern recognition or other automatic processes to recognize and identify the displayed furniture or equipment. The system 200 may use the information to create similar or matching virtual furniture or virtual equipment in the displayed space with the user. The visuals detected on screen may be propagated or replicated to create a more immersive environment.

In some embodiments, the system 200 recognizes and extends a three-dimensional plane 230 between the display system 206 and the environment 218 where the user is located. The system 200 provides coordination between the display of images and content on the display system 206 and the XR headset 204. For example, the display system 206 may provide information about an object that is moving in the display, including information about the trajectory and speed of the object. That system 200 shares that information with the XR headset 204, or other data processing systems such as the user computer 212 that control the XR headset 204 to provide a digital handoff of control of the presentation of the object. The system 200 may further collect information from sensors 208 and camera 210 to identify objects and their motion and interaction in the environment 218.

In some embodiments, the system 200 provides a linkage between an extended immersion and the content that is shown. For example, some longer duration immersive experiences may include multiple scenes or camera angles viewed on the display system 206. As the scenes change or camera angles change on the two-dimensional display system 206, the information displayed by the three dimensional XR system is automatically updated. For example, if a first scene appears outdoors in winter and involves many snowballs being thrown in the direction of the user, the virtual snowballs will appear to fly past the user and pile up in the environment 218. If a next scene that is inside a home, the virtual snowballs will be erased or eliminated to remain consistent with the new scene. This avoids accumulation of virtual elements in the virtual scene.

The system may accomplish this linkage or synchronization in any suitable fashion. In a first embodiment, there is communication of synchronization information about the scene change or camera angle change between the display system 206 and the XR headset 204. This may involve the user computer 212 as well. In another embodiment, the user computer 212 or other component may automatically recognize the scene change or camera angle change present in the content displayed on the display system 206 and automatically update the XR aspects of the immersive experience.

In some embodiments, the system 200 has awareness of the contents of the environment 218 including walls bordering the environment 218 and occlusions that may be contained in the environment. This may be, for example, a three-dimensional understanding of the environment 218 such as a map or a model stored in memory. This information may be developed by information received from sensors 208 and camera 210, for example, or from any other source. This information may be combined dynamically with the on-screen and existing content 223 to enhance the immersive experience for the user 202. For example, the XR immersive experience may be modified according the physics of objects in the video content displayed on the display system 206 interacting with physical objects in the environment. For example, if a paintball is fired in the direction of the user in the video presented on the display system, the paintball becomes virtualized in the user and rear plane extension 228 and, based on trajectory and other physics of the virtual paintball, hits the chair 220 or a wall or other occlusive feature of the environment 218 and creates a splat. This is more realistic and potentially more entertaining to the user 202 than the virtual paintball moving infinitely far behind the user 202 even though the user is in a confined space with other objects in the environment 218. The system 200 is aware of physical structures and objects in the environment 218 and adapts the immersive experience displayed to the user 202 accordingly.

In some examples, the environment 218 may include many users such as user 202. One example is a theater environment where multiple or even many users watch the display of the on-screen and existing content 223. Each respective users wears an appropriate XR headset or other XR viewing device such as XR headset 204.

In such embodiments, the system 200 collects information in building a three-dimensional model that includes information such as the location and viewing angle of each respective viewer. The system 200 adapts each respective immersive experience accordingly. For example, viewers sitting relatively high in the environment may see virtual paintballs hitting the seat back in front of them. Viewers sitting relatively low in the environment may see the same virtual paintballs pass over their heads and hit the seat back behind them. The view presented by the system 200 is thus locally cohesive for all co-located viewers. The viewers share a common three-dimensional environment automatically created by the system 200.

FIG. 2B is a block diagram illustrating operation of an example, non-limiting embodiment of a method 232 functioning within the communication network of FIG. 1 in accordance with various aspects described herein. The method 232 operates to provide an immersive, XR experience to a viewer 234. The system to implement the method 232 includes a display system 236, XR hardware 238, a content system 240, an XR content system 244, an orchestrator 246 and a metadata manager 248. In the illustrated embodiment, the system to implement the method 232 further includes a scene knowledge database 250 and a user profile database 252.

The viewer 234 may include one or more users who view content on the display system 236 using the XR hardware 238. The display system 236 may be any suitable display for displaying content items such as video programming. Examples include a television, flat panel display or any other device that may receive information to display the content item. The display system 206 of FIG. 2A is an example.

The XR hardware 238 may include any suitable device for creating an immersive experience for a user such as viewer 234. The XR headset 204 of FIG. 2A is an example. In embodiments where there are multiple viewers viewing the content item on the display system 236, such as in a theater, each respective user may employ respective XR hardware 238. Thus, the group of users may wear a group of XR headsets which may collectively be termed the XR hardware 238. In another example, some sporting events may combine real-life action with multiple displays. For example, in a hockey arena, fans are protected from on-ice action by a transparent barrier. The transparent barrier, or other surface, may be used to implement one or more display devices. A primary display may show the actual play of the game and a secondary display, not necessarily including an XR headset, may show overlay with XR immersive experiences that supplement the actual play of the game. The result is a combined effect of a two-dimensional display of video content, such as the live game action, with a three-dimensional XR immersive experience based on the two-dimensional display. Any suitable display devices including XR equipment may be combined.

The content system 240 provides data and other information forming one or more content items for display to the viewer 234 on the display 236. The content items may include previously existing content items, such as a film or video game, or may include live action content items such as a sports or entertainment event or live action video game. The content system 240 does analysis of content items such as videos. The content item may be received from any source including a local source or over a network. In one embodiment, the content system 240 receives a video or other feed from the display 236 and performs an analysis to determine composition of the content item, objects in the content item, spatial composition and other information.

The XR content system 244 provides content to the XR hardware 238 that corresponds to or relates to the content item provided by the content system 240. For example, the XR content system 244 may detect the content item being displayed by the content system 240, either through metadata received from the content system 240 which describes the content or through image recognition, and prepare XR content related to the content item for display by the XR hardware 238. The XR content system 244 enforces rules related to physics of objects being displayed, such as an object falling according to gravity or objects that collide and must bounce off or be deformed due to the collision.

The orchestrator 246 or XR multiplexer operates to receive information about the environment where the viewer 234 is located and coordinate display of virtual content with items or objects in the environment. The orchestrator 246 will operate to combine information including physics requirements with objects that are detected or need to be repeated in the local environment of the viewer 234.

The metadata manager 248 receives and communicates information including metadata among the other components of the system implementing the method 232. The scene knowledge database 250 receives, stores and communicates information about the environment where the viewer 234 is located. If the content being displayed on the display system 236 includes metadata with information about the scene being displayed on the display system 236, such as information that the scene takes place in a 1940 era jazz bar, that metadata may be stored in the scene knowledge database 250.

The user profile database 252 stores information about users including the viewer 234. The information in the user profile database 252 may be used to personalize an immersive experience for the viewer 234. For example, the viewer may specify preferences for an immersive experience, such as limitations on the speed at which objects move or the number of objects that may be populated in the virtual environment with the viewer 234. Such information may be stored and retrieved from the user profile database 252.

In one exemplary embodiment, at step 254, the viewer 234 activates or enables the system to begin displaying content. At step 256, the display provides images and other content to the viewer 234. This may be embodied as activating a set-top box which interacts with the display 236 and receives data defining content over a network.

As content playback begins, the system to implement the method 232 identifies objects and computes object trajectories as they appear in a scene being displayed. For example, the system to implement the method 232 begins to compute the depth of an object, either by computer vision techniques using a camera in the environment with the viewer 234, for example based on a two-dimensional analysis or by three-dimensional differentiation, such as using red-blue, pollination filter, time of flight, etc., or a metadata track. The metadata track may be from a provider of the content or may be computed from information from the display 236. Optionally, spatial locations of objects can be inferred or computed by an object's audio or other non-visual resolution, based on three-dimensional spatial sound capabilities. In other embodiments there may be encoding for three-dimensional depth of objects in the content itself.

At step 258, the display 236 communicates to the content system 240 information about what is being displayed on the display 236. For example, the content system 240 may perform image recognition for the content item to identify objects and actions in the content item. Alternatively, the display 236 may provide metadata and other information about the content being displayed to the content system 240. The content system 240 analyzes information received from the display 236 to understand the content being displayed.

Based on this analysis, the content system 240 provides information defining analytics for spatialization of objects in the content to the orchestrator 246, step 260. The analytics include information about objects in the scene using two-dimensional and three-dimensional analysis. There may be some information about spatial objects, where they are in the scene and how they are moving. This includes objects in the background that may be identified and tracked to make the XR scene more immersive for the viewer 234.

At step 262, a serialization process occurs. Based on the analytics provided at step 260, the orchestrator 246 retrieves from the scene knowledge database 250 information about objects located in the scene. Information retrieved may include information about relative size and placement and orientation of objects, and physics information, for example. The physics information may provide information about how one or more objects interact with other objects. Such information may be cached by the orchestrator 246. The orchestrator 246 may cooperate with the metadata manager 248 when accessing the scene knowledge database 250 or the user profile database, or both.

At step 264, the viewer 234 enables the XR operation to begin providing an immersive experience. At step 268, in response to the enablement of the XR immersion at step 264, a notification is sent to the XR content system 244. Either the display 236 or the XR hardware 238 may detect that the XR immersion has been enabled or that there is a potential three-dimensional object in the content that should be animated. In response, the notification of step 266 is generated. The notification indicates to the XR content system 244 that an object has been detected for which the XR content system can perform a spatial expansion.

At step 268, the XR immersive experience begins displaying to the viewer 234. For example, the XR immersive experience may be displayed using the XR hardware 238 and the XR immersive experience may be presented as an overlay or three-dimensional presentation of immersive content in conjunction with the two-dimensional content displayed on the display 236.

At step 270, in response to the notification received at step 266, the XR content system 244 advises the orchestrator that there is a moving object to be addressed. In response, the orchestrator 246 at step 274 performs a serialization process. The orchestrator 246 retrieves from the scene knowledge database 250 information about objects including the moving object, such as information about relative size and placement and orientation of objects, and physics information, for example. Further, the orchestrator 246 retrieves from the user profile database 252 information about preferences of the viewer 234, such as a preference of a safety radius from the viewer in an immersive experience. For example, the orchestrator 246 may perform an expansion limit setting process for the user experience. In one embodiment, to avoid distracting the viewer 234 with generated content outside the XR environment, the orchestrator 246 can establish or respond to a metric for limiting over-stimulation of the user with background content. Information about this metric may be stored in the user profile database 252, for example. Alternatively, the metric can be determined from the content being displayed or the context, such as a crowded room, objects in motion within the content, etc. The orchestrator 246 may cooperate with the metadata manager 248 when accessing the scene knowledge database 250 or the user profile database, or both.

The orchestrator 246 operates in a feedback loop for understanding of objects and resolution of objects. The orchestrator 246 coordinates what the displayed content is as well as what objects are moving within the displayed content and determines if an overlay is required, step 276. For example, the orchestrator 246 determines motion of an object within the two-dimensional display and computes a trajectory for the object outside the two-dimensional display into the three-dimensional space of the environment where the viewer 234 is located. The computed trajectory can include input information such as information about persons and objects in the three-dimensional space to avoid such persons and objects when performing the calculation. The orchestrator 246, at an appropriate time, computes an object placement and structure, step 278. Consistent with examples herein, the object might be a hockey puck or a snowball moving toward the viewer 234 as the viewer views the content on the display 236. Based on the computation, the orchestrator 246 sends a notification with data description to the XR content system 244.

The XR content system 244 receives the notification of step 278. The XR content system 244 determines how to animate the object and how to match the appearance of the object including lighting and perspective and so forth. The XR content system 244 coordinates the physics of the object so that the object responds appropriately when engaging other real or virtual objects. At step 280, the information from the XR content system 244 is provided to the XR hardware 238, such as an XR headset, and is then displayed as an overlay to the user or viewer 234, step 282.

Steps 254 through 282 of FIG. 2B correspond to initial operation and normal operation of the system to implement the method 232. Generally, the method identifies objects in the two-dimensional content that may need to be presented as an overlay in the three-dimensional or XR space, determines motion, trajectory, physics and other information for the objects and adds the objects to the three-dimensional environment for display on the XR hardware 238 to the viewer 234. Steps 284 through 292 illustrate operation for handling a local depth occlusion in the three-dimensional environment including the viewer 234.

At step 284, information about the environment or room where the viewer 234 is located is captured. This may be done, for example, by means of computer vision including information captured by one or more cameras in the environment or through one or more sensors or other devices, or by manual input by the viewer 234 or by any other suitable method. The information about the space may include location and dimensions of objects in the environment, information about movement of objects such as people including body parts such arms of people, and including trajectory and velocity. The information may include data about materials that make up objects, such as metal, wood or glass. This information about the environment may be updated as the environment changes to remain current with conditions in the environment. The information may be collected by the XR hardware 238 or by any other source.

At step 286, the XR content system 244 resolves the depth of objects in the room. For example, the XR content system may develop a three-dimensional map of the environment with information about the objects, their location, their movement and their physics. For example, if an object is rigid, it may respond to a virtual collision with a virtual object differently than a soft object such as a piece of furniture. Further, the XR content system 244 resolves objects or trajectories against the user environment to avoid a visual appearance of a virtual object in an object where the depth is not appropriate.

At step 288, the XR content system 244 provides spatial integration information to the orchestrator 246. In general, the information that the XR content system 244 has determined about the environment where the viewer 234 is located is shared with the orchestrator 246. At step 290, the orchestrator may recompute an integration to include the information about the environment. Control returns to step 276 for further processing by the orchestrator 246.

Subsequently, the orchestrator 246 can use the recomputed integration to modify generation and display of objects in the three-dimensional XR immersive experience for the viewer 234. The orchestrator 246 may cooperate with the XR content system 244 to accomplish this modification or adaptation. For example, the orchestrator 246 may adapt the generation of XR objects according to location of the viewer 234, including movement of the viewer 234, such as the arms of the viewer. Further, the orchestrator may adapt the generation of XR objects according to location, texture, physics and other properties of the identified objects in the room. In one example, if a virtual snowball generated by the XR content system 244 goes past the viewer in the three-dimensional XR space, and the orchestrator 246 will be aware that there is a solid wall behind the viewer 234 in the environment. Visually, the XR content system 244 may cause the virtual snowball to hit the wall and melt. Audibly, the XR content system 244 may produce a suitable sound such as a metal ringing if the wall is metallic or a sound of breaking glass the wall is made of glass. Other possibilities for sensory feedback may be employed as well.

At step 292, haptic feedback may be provided to the viewer 234. For example, the XR hardware 238 may include a haptic sensor positioned on or near the user. In the example, if the virtual snowball is aimed at the viewer in the XR immersion, the haptic sensor may vibrate or cause another sensation for the user to indicate collision of the virtual snowball with the viewer 234. Other sensory input or feedback to the viewer may be provided by the XR hardware 238 as well, including wind, temperature variation, sound playback, and others.

Steps 294 through 298 represent a process for handling a local depth occlusion. Such an occlusion may be due to objects in the environment with the viewer 234 such as a lamp or piece of furniture that blocks a portion of the display 236. Such an occlusion must be accounted for when rendering the images of the XR immersive experience. At step 294, analytic information about the content item being displayed on the display 236 is provided to the orchestrator 246. At step 296, the XR content system 244 performs a spatial integration to accommodate the occlusion. At step 298, the integration is recomputed and control returns to step 276 to update the XR immersive experience.

Some embodiments provide for updating scenes and managing persistence of virtual objects in the three-dimensional space of the XR immersive experience. In an example, thrown virtual snowballs accumulate behind the viewer 234 in an outdoor scene of the immersive experience. If the content on the display 236 changes to an indoor scene, the virtual snowballs should not continue to be displayed on the immersive display of the XR hardware 238. At step 298, a timing resolution may be performed to manage content such as the virtual snowballs that may be considered stale. Control returns to step 276.

A system and method in accordance with embodiments herein add depth capabilities to video content and other content displayed on a flat screen. The two-dimensional display of a display screen, such as a television, mobile device or movie theater screen, is extended to three dimensions by combining the flat screen with XR hardware such as an XR headset. An XR immersive experience is automatically created to operate synchronously with the video content and to create virtual objects that appear in the depth of the environment occupied by the viewer. Even in the of video content that is designed to give the impression of three-dimensional video on a two-dimensional screen, the three-dimensional effect is heightened and brought into the room with the viewer, including in the space between the viewer and the two-dimensional screen.

Moreover, in some embodiments, the system and method can detect the positioning of the viewer in the environment, including a distance or depth between the two-dimensional screen surface and the viewer, such as the viewer's face. If the screen surface is nominally deptho, the system and method may adjust all presentation of video so that the adjusted deptho is at the viewer's face or some other position of interest. All three-dimensional video content will be generated to appear relative to the adjusted deptho.

In some embodiments, the system and method operate to synchronize the virtual or three-dimensional environment and an original broadcast camera view. As the camera view changes, the generated virtual view will change as well. The view can change due to switching from one camera's view of a scene to a second camera's view of a scene, or due to movement of the camera relative to the scene. Further, the system and method may synchronize the virtual presentation with the environment of the user, adjusting the immersion to accommodate walls and other objects in the environment with the viewer. The system and method may receive metadata information about the view of the camera or the system may use image recognition or other methods to monitor the images displayed on the two-dimensional screen and tailor the three-dimensional, virtual images accordingly, synchronized with the two-dimensional images.

In some embodiments, the system may provide haptic feedback. The haptic feedback reflects or emphasizes or enhances the visual experience of the immersion. This may be done through any suitable haptic feedback equipment, including for example, an XR headset or googles worn by the user, a haptic vest to physically engage the viewer, one or more fans to move air, and audio equipment for sound feedback.

In some embodiments, the system and method provide a coordinated system for spatialized visual and sound hand-off and cooperation. If the environment includes a local audio system, such as a 7.1 surround sound audio system in a home theater or if the viewer wears headphones or a bone conductance device, the audio sources may be coordinated. Such embodiments may be further adapted to accommodate multiple viewers located at multiple positions in the environment.

Some aspects of the illustrated system and method may require substantial computational resources for implementation. For example, the content system 240 must recognize items and objects and people and motion in the two-dimensional content item provided to the display system 236. In some embodiments, this is done using pattern recognition to identify and classify such shapes and track motion. Also, the XR content system 244 operates to respond to the two-dimensional content item and to generate or modify the three-dimension immersive experience. Other aspects of the illustrated system to implement the method 232 may require processing large amounts of data, storing large amounts of data and communicating large amounts of data over one or more networks.

In some embodiments, the system and method may use a repository of models of objects to determine an extension from two-dimensional content to three-dimensional virtual objects. For example, image recognition may be used to identify an object in the two-dimensional content. Based on a recognized image, a model stored in the repository may be identified and selected. As further details of the object are identified, the model can be modified until an accurate three-dimensional object is developed. Using a model can reduce the amount of computer processor power required to compute the extension from two-dimensions to three-dimensions, reduce the time to compute the extension, or both.

In some embodiments, the system and method may use distributed computing to compute audio and visual aspects of the immersive experience. The XR hardware 238, for example, may be well adapted to presenting video immersive experiences but not to identifying objects in a two-dimensional content item. In such a case, processing of particular aspects such as pattern recognition may be assigned to other data processing systems accessible over one or more networks. One example is user computer 212 and AR server 214 in FIG. 2A which cooperate with XR headset 204.

In other embodiments, the system and method may detect metadata in the two-dimensional content stream and use the metadata to identify objects, including moving objects, in the two-dimensional content stream. In some embodiments, a Quick Response (QR) code, digital watermark or other visual information may be contained in the two-dimensional content stream. The visual element may include encoded data identifying the object, features of the object, motion of the object such as trajectory and velocity, appearance of the object including color and surface texture, physics of the object, and so forth. The encoded data may be decoded to identify information including visual information about the object. Upon identifying the visual information, the system and method may use the visual information to identify an object in the two-dimensional content stream and begin computing features and movement of an extension from a two-dimensional object to three-dimensional object. Using such visual information can reduce the amount of computer processor power required to compute the extension from two-dimensions to three-dimensions, reduce the time to compute the extension, or both.

In some embodiments, the system and method may implement an electronic commerce feature. For example, an advertiser can pay to a content provider or other party a fee to include advertising in the three-dimensional immersive experience. In the example including virtual snowballs that eventually disappear from view, a heating and air conditioning contractor may pay a fee to the content provider to have the snowballs persist in the image for a longer time, and add an image of the contractor's brand or logo.

In some embodiments, the system and method may extend visual aspects of the immersive experience to other sensory modalities such as smell, auditory and haptic. Such operation may be triggered as recognized extensions of on-screen content in the two-dimensional content stream. For example, if the system and method identify an apple pie in the two-dimensional content, the XR hardware 238 may generate a suitable aroma to convey to the viewer 234 to enhance the immersive experience. Further, in some embodiments, the generation of the aroma may be varied over time with the visual variation in the two-dimensional content. For example, as the apple pie appears to come closer to the viewer 234, the aroma grows stronger for the viewer 234.

In some embodiments, the system and method may use six degrees of freedom (6DoF) to change parallax on a display screen. Six degrees of freedom refers to the freedom of movement of a rigid body in three-dimensional space. For example, if the viewer moves around the environment, the system and method may identify the movement and change the view presented by the three-dimensional immersive experience. Moreover, the system may initiate a change in the two-dimensional on-screen content to reflect the change in position and change in view. This may be done even if the two-dimensional content is pre-filed or captured. The positioning and orientation of the viewer may be determined using sensors in the environment, sensors of the XR hardware or cameras that view the environment.

While for purposes of simplicity of explanation, the respective processes are shown and described as a series of blocks in FIG. 2B, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

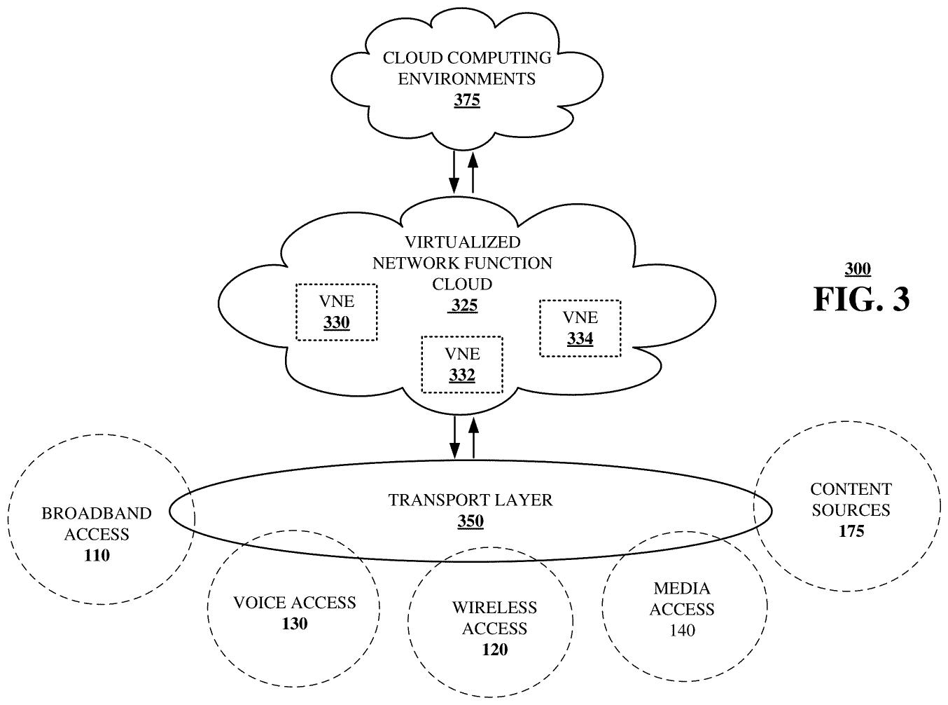

Referring now to FIG. 3, a block diagram is shown illustrating an example, non-limiting embodiment of a virtualized communication network 300 in accordance with various aspects described herein. In particular a virtualized communication network is presented that can be used to implement some or all of the subsystems and functions of system 100, the subsystems and functions of system 200, and method 232 presented in FIGS. 1, 2A, 2B, 2C, and 3. For example, virtualized communication network 300 can facilitate in whole or in part receiving a two-dimensional content item over a network for viewing by a user, identifying a moving object in the two-dimensional content item and initiating a three-dimensional extended reality immersive experience for viewing by the user in conjunction with the two-dimensional content item to create effect that the moving object is moving into the virtual environment of the immersive experience toward the user.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements—which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general purpose processors or general purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it's elastic: so the resources are only consumed when needed. In a similar fashion, other network elements such as other routers, switches, edge caches, and middle-boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized, and might require special DSP code and analog front-ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements don't typically need to forward large amounts of traffic, their workload can be distributed across a number of servers—each of which adds a portion of the capability, and overall which creates an elastic function with higher availability than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud, or might simply orchestrate workloads supported entirely in NFV infrastructure from these third party locations.

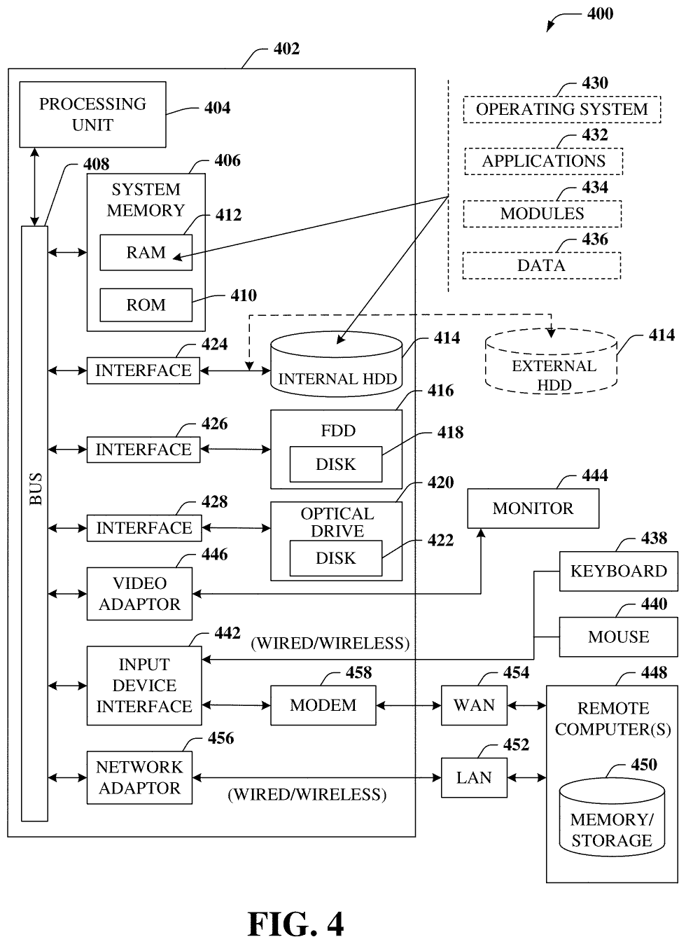

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part receiving a two-dimensional content item over a network for viewing by a user, identifying a moving object in the two-dimensional content item and initiating a three-dimensional extended reality immersive experience for viewing by the user in conjunction with the two-dimensional content item to create effect that the moving object is moving into the virtual environment of the immersive experience toward the user.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM),flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

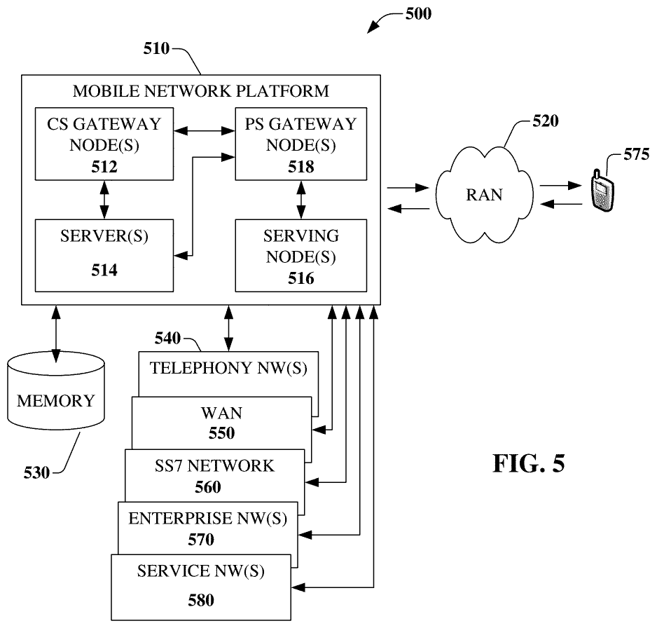

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part receiving a two-dimensional content item over a network for viewing by a user, identifying a moving object in the two-dimensional content item and initiating a three-dimensional extended reality immersive experience for viewing by the user in conjunction with the two-dimensional content item to create effect that the moving object is moving into the virtual environment of the immersive experience toward the user. In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks, and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technologies utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processor can execute code instructions stored in memory 530, for example. It is should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

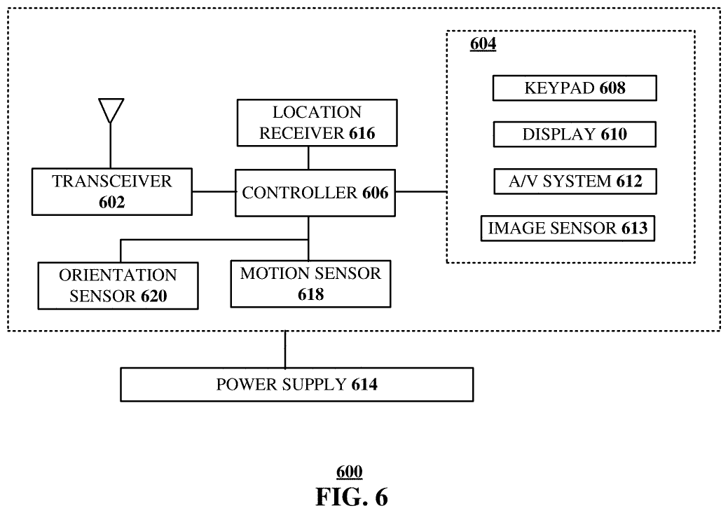

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, computing device 600 can facilitate in whole or in part receiving a two-dimensional content item over a network for viewing by a user, identifying a moving object in the two-dimensional content item and initiating a three- dimensional extended reality immersive experience for viewing by the user in conjunction with the two-dimensional content item to create effect that the moving object is moving into the virtual environment of the immersive experience toward the user.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, WiFi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, WiFi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x1, x2, x3, x4, . . . , xn), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A device, comprising:
a processing system including a processor; and
a memory that stores executable instructions that, when executed by the processing system, facilitate performance of operations, the operations comprising:
receiving a content item for displaying in a display system, the display system having a viewing plane;
identifying an object in the content item;
initiating an immersive experience for a user, wherein the immersive experience is based on the identifying of the object and wherein the immersive experience includes a virtual object presented in a virtual environment with the user and appearing to the user to move from the viewing plane of the display system into the virtual environment with the user, wherein the virtual object is based on the object; and
providing data defining the immersive experience to extended reality hardware for interaction by the user.

2. The device of claim 1, wherein the operations further comprise:
detecting a visual element in the content item;
based on the visual element, detecting the object; and
based on the detecting the object, computing features and movement of the virtual object as an extension of the object in the content item.

3. The device of claim 2, wherein the operations further comprise:
based on the visual element, retrieving from storage a model of the object to reduce computational requirements for computing the features and movement of the virtual object; and
based on the model, determining the features and movement of the virtual object.

4. The device of claim 2, wherein the detecting a visual element in the content item comprises:
identifying a digital watermark in a content stream forming the content item; and
determining, from the digital watermark, features of the object.

5. The device of claim 1, wherein the receiving a content item for displaying in a display system comprises receiving data defining a two-dimensional video presentation for display on the display system.

6. The device of claim 5, wherein the data defining a two-dimensional video presentation comprises data defining a sports program and wherein the object comprises a game piece of the sports program, the game piece having an apparent trajectory and an apparent velocity in the sports program, and wherein virtual object comprises a virtual representation of the game piece appearing in the immersive experience to move from the viewing plane of the display system into the virtual environment with the apparent trajectory and the apparent velocity of the game piece as viewed in the sports program.

7. The device of claim 6, wherein the operations further comprise:
identifying one or more objects in the virtual environment with the user; and
modifying the apparent trajectory, the apparent velocity of the virtual representation of the game piece based on the identifying the one or more objects.

8. The device of claim 1, wherein the operations further comprise:
identifying a scene change in the content item; and
updating appearance of the virtual object in the virtual environment based on the scene change.

9. A machine-readable medium, comprising executable instructions that, when executed by a processing system including a processor, facilitate performance of operations, the operations comprising:
receiving information defining a two-dimensional video content item;
displaying the two-dimensional video content item on a two-dimensional display system having a viewing plane;
identifying an object in the two-dimensional video content item, the object being viewable by a user in a video presentation on the two-dimensional display system;
initiating an immersive experience for displaying to a user on extended reality hardware operated in conjunction with the two-dimensional display system, wherein the immersive experience includes presenting on the extended reality hardware a virtual object presented in a virtual environment with the user and appearing to the user to move from the viewing plane of the two-dimensional display system into the virtual environment with the user, wherein the virtual object is based on the object;
providing, to the extended reality hardware, data defining the immersive experience;
receiving user interaction with the virtual object in the virtual environment;
modifying an aspect of the virtual object responsive to the user interaction with the virtual object; and
providing, to the extended reality hardware, updated data defining a modified aspect of the virtual object.

10. The machine-readable medium of claim 9, wherein the operations further comprise:
identifying one or more physical objects in a physical environment with the user, the virtual environment with the user of the immersive experience being overlaid on the physical environment with the user;
identifying an interaction between the virtual object and the one or more physical objects;
modifying a further aspect of the virtual object responsive to the interaction between the virtual object and the one or more physical objects; and
providing, to the extended reality hardware, updated data defining the modified further aspect of the virtual object.

11. The machine-readable medium of claim 10, wherein the identifying an interaction between the virtual object and the one or more physical objects comprises:
determining a motion of the virtual object in the virtual environment that will position the virtual object inside a physical object of the one or more physical objects; and
altering the motion of the virtual object responsive to the determining the motion.

12. The machine-readable medium of claim 10, wherein the identifying the one or more physical objects in a physical environment with the user comprises:
viewing the physical environment with a computer vision system;
locating the one or more physical objects;
characterizing the one or more physical objects; and
storing a three-dimensional map of the physical environment.

13. The machine-readable medium of claim 9, wherein the identifying an object in the two-dimensional video content item comprises:
detecting a visual element in the two-dimensional video content item;
decoding the visual element to determine decoded information about the object; and
based on the decoded information, identifying the object in the two-dimensional video content item.

14. The machine-readable medium of claim 9, wherein the providing the data defining the immersive experience comprises:
providing data defining a three-dimensional extended reality immersive experience to an extended reality headset of a user positioned before the two-dimension display system, the data defining a three-dimensional extended reality immersive experience operative to create images for the user on the extended reality headset corresponding to the two-dimensional video content item displayed on the two-dimensional display system so that objects moving in the two-dimensional video content item displayed on the two-dimensional display system appear to move toward the user in the three-dimensional extended reality immersive experience viewed by the user in the extended reality headset.

15. A method, comprising:
receiving, by a processing system including a processor, a video content item for display to a user on a two-dimensional display system, the two-dimensional display system having a viewing plane;
identifying, by the processing system, a moving object in the video content item when the video content item is displayed on the two-dimensional display system, wherein the moving object has visual properties, and wherein the moving object appears to move toward the viewing plane of the two-dimensional display system;
generating, by the processing system, a virtual object having visual properties matching the visual properties of the moving object; and
providing, by the processing system, data defining the virtual object to extended reality hardware viewable by the user together with the two-dimensional display system, the extended reality hardware displaying a three-dimensional virtual environment to the user in a physical environment spaced from the viewing plane of the two-dimensional display system, the data defining the virtual object causing the virtual object to appear to move from the viewing plane of the two-dimensional display system the two toward the user in the three-dimensional virtual environment.

16. The method of claim 15, wherein the identifying the moving object in the video content item comprises:
receiving, by the processing system, metadata, wherein the metadata is associated with the video content item; and
determining, by the processing system, information about the moving object responsive to the metadata and operates to reduce an amount of time required to identify the moving object in the video content item.

17. The method of claim 15, further comprising:
identifying, by the processing system, one or more physical objects, including the user, in the physical environment;
identifying, by the processing system, an interaction between the virtual object and the one or more physical objects;
modifying, by the processing system, a motion of the virtual object in response to the interaction between the virtual object and the one or more physical objects; and
providing, by the processing system, updated data defining the virtual object to extended reality hardware, wherein the updated data reflects the modifying the motion of the virtual object.

18. The method of claim 17, comprising:
providing, by the processing system, haptic responses to the user, the haptic responses based on and interaction between the virtual object and the user.

19. The method of claim 15, comprising:
synchronizing, by the processing system, the three-dimensional virtual environment displayed to the user by the extended reality hardware and the video content item displayed to the user on the two-dimensional display system, wherein the synchronizing comprises synchronizing in time and in point of view.

20. The method of claim 15, comprising:
displaying, by the processing system, the video content item on the two-dimensional display system and the three-dimensional virtual environment on the extended reality hardware to a plurality of viewers including the user, wherein the plurality of viewers are located in the physical environment to view the two-dimensional display system and wherein the extended reality hardware comprises a plurality of extended reality headsets, each respective extended reality headset worn by a respective viewer of the plurality of viewers.
